(19) United States
(12) Patent Application Publication
(10) Pub. No.: US 2016/0261509 A1
(43) Pub. Date: Sep. 8, 2016

(54) METHOD FOR PERFORMING UPLINK TRAFFIC SHAPING OF AN ELECTRONIC DEVICE WITH AID OF ALARM-AWARE MECHANISM, AND ASSOCIATED APPARATUS

(71) Applicant: MEDIATEK INC., Hsin-Chu (TW)

(72) Inventors: Jun-Hua Chou, Taipei City (TW); Wen-Hung Su, New Taipei City (TW); Chia-Chun Hsu, New Taipei City (TW); Yu-Pin Lin, Hsinchu County (TW)

(21) Appl. No.: 14/846,831

(22) Filed: Sep. 7, 2015

Related U.S. Application Data
(60) Provisional application No. 62/129,093, filed on Mar. 6, 2015.

(51) Int. Cl. H04L 12/815; H04W 52/02

(52) U.S. Cl. CPC H04L 47/22; H04W 52/0209

(57) ABSTRACT

A method for performing uplink traffic shaping of an electronic device and an associated apparatus are provided, where the method includes the steps of: monitoring at least one modulator-demodulator (modem) state of a radio modem of the electronic device; and according to the at least one modem state and according to at least one uplink traffic gating strategy, dynamically controlling whether to allow uplink traffic to pass through the radio modem, and more particularly, in a situation an alarm-aware uplink traffic gating strategy is involved, determining whether a time interval between a wake-up type alarm trigger and a last time point when uplink traffic is previously allowed because of another alarm trigger reaches a predetermined alarm-triggered gate open threshold; and controlling whether to allow uplink traffic to pass through the radio modem according to whether the time interval reaches the predetermined alarm-triggered gate open threshold.

### CROSS REFERENCE TO RELATED APPLICATIONS

This application claims the benefit of U.S. Provisional Application No. 62/129,093, which was filed on Mar. 6, 2015, and is included herein by reference.

### BACKGROUND

The present disclosure relates to intelligent uplink traffic control of a system, and more particularly, to a method for performing uplink traffic shaping of an electronic device, and an associated apparatus.

According to the related art, applications running on a conventional portable electronic device such as a conventional multifunctional mobile phone may drain the battery of the conventional portable electronic device quickly, and the user of the conventional multifunctional mobile phone may complain about such a high power consumption problem. For example, plenty of applications running on the conventional portable electronic device may transmit data in a sleep mode of the conventional portable electronic device, and the transmissions due to these applications may lead to many device wake-up events, which may cause the conventional multifunctional mobile phone to drain the battery thereof quickly. As a result, in a situation where the user does not use the conventional multifunctional mobile phone frequently during one day, the user may still feel that the conventional multifunctional mobile phone battery needs charging very fast. In order to solve the high power consumption problem, some conventional methods are proposed in the related art. However, additional problems such as side effects may occur.

In addition, the user of the conventional multifunctional mobile phone may feel that the battery draining speed of the conventional multifunctional mobile phone is higher than that of a conventional feature phone. For example, in a situation where some of the conventional methods are applied, the user may still feel that the standby time of the conventional multifunctional mobile phone is not as long as the standby time of a conventional feature phone.

In conclusion, the related art does not solve the long-time existed problem. Therefore, a novel architecture for uplink traffic control of an electronic device is required for enhancing the power consumption performance.

### SUMMARY

It is an objective of the disclosure to provide a method for performing uplink traffic shaping of an electronic device, and an associated apparatus, in order to solve the above mentioned problems, enhance overall performance, and improve the experience of the user.

According to one implementation, a method for performing uplink traffic shaping of an electronic device is provided, where the method is applied to the electronic device. The method comprises the steps of: monitoring at least one modulator-demodulator (modem) state of a radio modem of the electronic device; and according to the modem state and an uplink traffic gating strategy, dynamically controlling whether to allow uplink traffic to pass through the radio modem.

According to one implementation, an apparatus for performing uplink traffic shaping of an electronic device is provided, where the apparatus comprises a portion or all of the electronic device. The apparatus comprises a processing circuit that is arranged for controlling operations of the electronic device, and the processing circuit comprises a monitoring module and a traffic control module. In addition, the monitoring module is arranged for monitoring the modem state of a radio modem of the electronic device. Additionally, the traffic control module is arranged for performing uplink traffic control for the electronic device, wherein according to the modem state and according to the uplink traffic gating strategy, the traffic control module dynamically controls whether to allow uplink traffic to pass through the radio modem.

It is an advantage of the present disclosure that the present disclosure method and the associated apparatus can enhance the overall performance of electronic devices. In addition, the present disclosure method and the associated apparatus can improve the experience of the user.

These and other objectives of the present disclosure will no doubt become obvious to those of ordinary skill in the art after reading the following detailed description of the implementation that is illustrated in the various figures and drawings.

### BRIEF DESCRIPTION OF THE DRAWINGS

FIG. 1 is a diagram of an apparatus for performing uplink traffic shaping of an electronic device according to an implementation of the present disclosure.

FIG. 2 illustrates a multifunctional mobile phone involved with the apparatus shown in FIG. 1 according to an implementation of the present disclosure.

FIG. 3 illustrates a flowchart of method for performing uplink traffic shaping of an electronic device according to an implementation of the present disclosure.

FIG. 4 illustrates an uplink traffic shaping control scheme involved with the method shown in FIG. 3 according to an implementation of the present disclosure.

FIG. 5 illustrates an alarm-aware mechanism involved with the method shown in FIG. 3 according to an implementation of the present disclosure.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

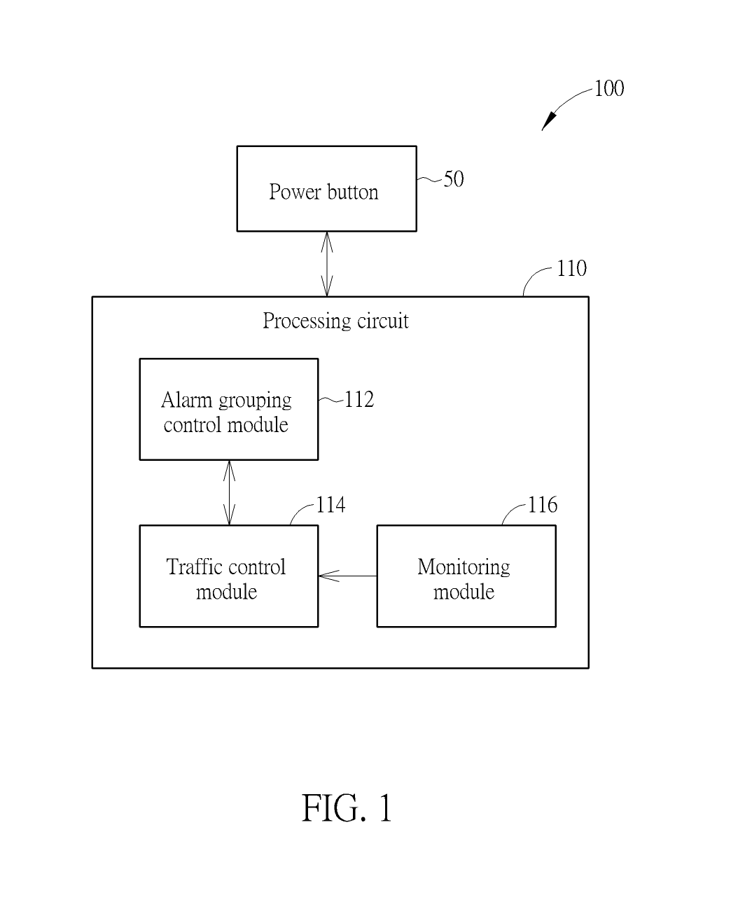

FIG. 1 is a diagram of an apparatus 100 for performing uplink traffic shaping of an electronic device according to an implementation of the present disclosure, where the apparatus 100 may comprise at least one portion (e.g. a portion or all) of the electronic device. For example, the apparatus 100 may comprise a portion of the electronic device mentioned above, such as at least one hardware circuit within the electronic device. In another example, the apparatus 100 can be the whole of the electronic device mentioned above. In another example, the apparatus 100 may comprise a system comprising the electronic device mentioned above (e.g. an information processing system comprising the electronic device). Examples of the electronic device may include, but not limited to, a mobile phone (e.g. a multifunctional mobile phone), a personal digital assistant (PDA), a tablet, a wearable device and a personal computer such as a laptop computer.

As shown in FIG. 1, the apparatus 100 may comprise a processing circuit 110 which may be capable of controlling operations of the electronic device. For example, the processing circuit 110 may be capable of controlling one or more operations of the electronic device with aid of one or more alarms. According to this implementation, the processing circuit 110 may comprise an alarm grouping control module 112, a traffic control module 114, and a monitoring module 116. The alarm grouping control module 112 is arranged for performing alarm grouping control for the electronic device. In addition, the traffic control module 114 is arranged for performing uplink traffic shaping control for the electronic device. For example, the traffic control module 114 may be aware of some alarm grouping control operations performed by the alarm grouping control module 112 and the associated alarm grouping results thereof, and may perform uplink traffic shaping control operations in an alarm-aware manner. Additionally, the monitoring module 116 is arranged for monitoring one or more modulator-demodulator (modem) states of a radio modem of the electronic device, where the processing circuit 110 may perform uplink and/or downlink transmission operations through the radio modem. As a result, the traffic control module 114 may be aware of the aforementioned one or more modem states and perform uplink traffic shaping control operations in response to the aforementioned one or more modem states.

More particularly, the alarm grouping control module 112 is capable of shifting an execution timing of at least one alarm of a plurality of alarms to group the plurality of alarms into at least one grouped alarm according to at least one grouping control strategy, wherein the execution timing of the at least one alarm may be shifted to an execution timing of the aforementioned at least one grouped alarm. For example, the alarm grouping control module 112 may comprise a wake-up control sub-module (not shown) capable of controlling whether to wake up at least a portion of the electronic device according to the aforementioned at least one grouped alarm. Please note that an execution timing of an alarm may represent an execution time point of this alarm, such as a time point on the time axis.

The alarm grouping control may be triggered by one or more predetermined conditions. For one example, the alarm grouping control may be triggered when the remaining power of the battery of the electronic device is lower than a threshold. For another example, the alarm grouping control may be triggered every predetermined period of time. For still another example, the alarm grouping control may be triggered if a screen of the electronic device is off for a predetermined period of time. In this implementation, the processing circuit 110 maybe further capable of comparing a time period during which a screen of the electronic device is kept off with a predetermined threshold to generate a comparing result, and the processing circuit 110 may be further capable of determining whether to perform alarm grouping control according to the comparing result. For example, the screen of the electronic device may be kept off for M minutes and the processing circuit 110 may find that M is not less than a predetermined threshold N, and then the processing circuit 110 may determine that alarm grouping control should be performed or triggered. The screen may be turned off in many ways. For example, a power button 50 may be pressed to turn off the screen of the electronic device. According to some implementations, in order to prevent some unpleasant user experience problems in the related art, the processing circuit 110 may perform alarm grouping control according to at least one grouping control strategy (e.g. one or more grouping control strategies), where the aforementioned at least one grouping control strategy may comprise a self-learning strategy (which may be implemented with the self-learning application grouping policy), a recovery strategy (which may be implemented with the recovery mechanism), a white type strategy (which maybe implemented with one or more white types), and a conditional trigger strategy. As a result of performing alarm grouping control operations by using the alarm grouping control module 112, the power consumption may be reduced with less side effects.

Although the alarm grouping control module 112 and the wake-up control sub-module embedded therein, the traffic control module 114, and the monitoring module 116 in this implementation are included in the processing circuit 110, a portion or the entirety thereof can be external to the processing circuit 110 in some implementations. The alarm grouping control module 112 and the wake-up control sub-module embedded therein, the traffic control module 114, and the monitoring module 116 can be implemented by hardware, software, firmware or a combination thereof. For example, the alarm grouping control module 112 and the wake-up control sub-module embedded therein, the traffic control module 114, and the monitoring module 116 can be implemented by program codes read from a storage internal or external to the processing circuit 110 and executed by at least a portion of the processing circuit 110. When at least one operation (e.g. one or more operations) regarding alarm grouping control and/or uplink traffic control is performed, as the time interval (s) between the congregated execution(s) of alarms and/or the time interval(s) of uplink traffic may be properly controlled, the processing circuit 110 can reduce the total number of wakeups and the total number of occurrence of high power consumption state(s) of the radio modem of the electronic device, and further reduce the power consumption correspondingly.

In one implementation, the processing circuit 110 may execute program codes (e.g. program instructions), and may comprise at least one processor (e.g. one or more processors) such as a computer processor for executing the program codes. Although the program codes may be contained in the processing circuit 110, it can be stored in any storage located anywhere that the processing circuit 110 can access. For example, one or more modules within the alarm grouping control module 112, the traffic control module 114, and the monitoring module 116 can be program modules running on the aforementioned at least one processor. This is for illustrative purposes only, and is not meant to be a limitation of the present disclosure.

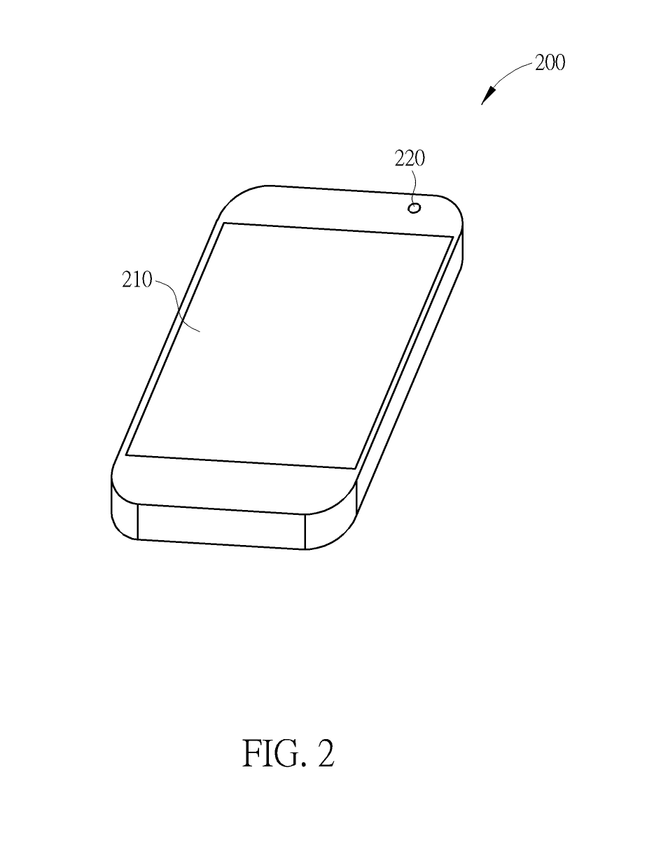

FIG. 2 illustrates a multifunctional mobile phone 200 involved with the apparatus 100 shown in FIG. 1 according to an implementation of the present disclosure, where the multifunctional mobile phone 200 can be taken as an example of the electronic device mentioned above. This is for illustrative purposes only, and is not meant to be a limitation of the present disclosure. According to some implementations, any other electronic device (e.g. another type of electronic device, such as an electronic device that is not a multifunctional mobile phone) can be taken as an example of the electronic device mentioned above. As shown in FIG. 2, the multifunctional mobile phone 200 may comprise a touch sensitive display module 210 (e.g. a touch screen) and a camera 220, where the touch sensitive display module 210 can be taken as an example of the screen mentioned in the implementation shown in FIG. 1. This is for illustrative purposes only, and is not meant to be a limitation of the present disclosure.

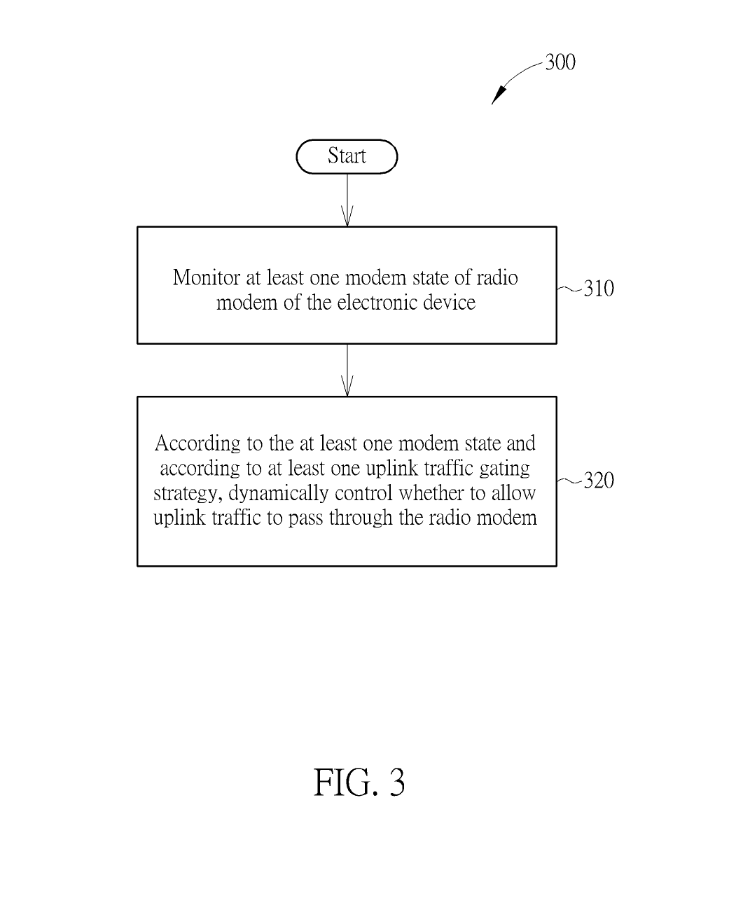

FIG. 3 illustrates a flowchart of method 300 for performing uplink traffic shaping of an electronic device according to an implementation of the present disclosure. The method 300 shown in FIG. 3 can be applied to the apparatus 100 shown in FIG. 1 and the multifunctional mobile phone 200 of the implementation shown in FIG. 2, and can be applied to the processing circuit 110 executing the program codes. For example, the program codes maybe provided through a computer program product having program instructions (such as those mentioned above) for instructing a processing circuit such as that mentioned above to perform the method 300 shown in FIG. 3 (or at least one portion of operations of the method 300, such as one or more operations of any of the control schemes in the subsequent implementations), where the computer program product may be implemented as a non-transitory computer-readable medium (e.g. a floppy disk or a compact disc-read only memory (CD-ROM)) storing the program instructions or an equivalent version thereof, such as a software package for being installed. This is for illustrative purposes only, and is not meant to be a limitation of the present disclosure. The method can be described as follows.

In Step 310, the processing circuit 110 (e.g. the monitoring module 116 thereof) may monitor at least one modem state (e.g. one or more modem states of the radio modem) of the radio modem of the electronic device. For example, any modem state within the aforementioned at least one modem state may be a radio resource control (RRC) state of the radio modem.

In Step 320, according to the aforementioned at least one modem state (of Step 310) and according to at least one uplink traffic gating strategy (e.g. one or more uplink traffic gating strategies), the processing circuit 110 (e.g. the traffic control module 114) may dynamically control whether to allow uplink traffic to pass through the radio modem.

In practice, the radio modem may send an idle indicator such as the RRC_IDLE Indication to the processing circuit 110 when changing from a RRC Connected state to a RRC Idle state, or may send a connection indicator such as the RRC_CONN Indication to the processing circuit 110 when changing from the RRC Idle state to the RRC Connected state due to downlink traffic arrival. By monitoring whether the idle indicator such as the RRC_IDLE Indication is received from the radio modem, the processing circuit 110 (e.g. the monitoring module 116 thereof) may detect the RRC Idle state when receiving the idle indicator such as the RRC_IDLE Indication. In addition, by monitoring whether the connection indicator such as the RRC_CONN Indication is received from the radio modem, the processing circuit 110 (e.g. the monitoring module 116 thereof) may detect the RRC Connected state when receiving the connection indicator such as the RRC_CONN Indication. Additionally, the operations of Step 310 and Step 320 may be repeatedly performed.

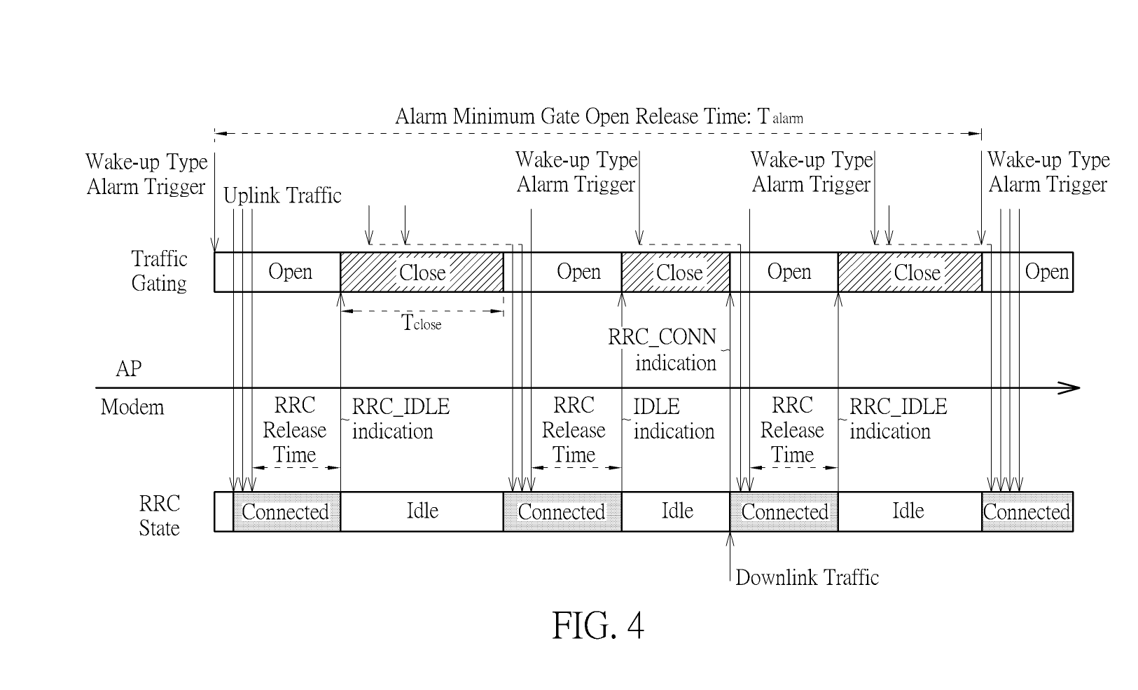

FIG. 4 illustrates an uplink traffic shaping control scheme involved with the method 300 shown in FIG. 3 according to an implementation of the present disclosure. This uplink traffic shaping control scheme applies most of the operations described above to the apparatus 100, and more particularly, to the processing circuit 110. The horizontal axis represents the time axis, where the upper portion (above the time axis) may correspond to the operations of the processing circuit 110 running some applications (labeled “AP” in FIG. 4, for better comprehension), and the lower portion (below the time axis) may correspond to the radio modem (labeled “Modem” in FIG. 4, for brevity).

Please note that what is performed by the processing circuit 110 using an uplink traffic gating mechanism within the electronic device may be referred to as traffic gating. As shown in FIG. 4, the traffic gating operations may correspond to the RRC states. For example, the uplink traffic gate implemented according to this uplink traffic shaping control scheme may open when the radio modem is in the connected state (e.g. the RRC Connected state), or may close when the radio modem is in the idle state (e.g. the RRC Idle state). In addition, some downward arrowheads shown in FIG. 4 may represent uplink traffic and some others may represent wake-up type alarm triggers, while the upward arrowhead shown around the bottommost of FIG. 4 may represent downlink traffic. For brevity, similar descriptions for this implementation are not repeated in detail here. For better comprehension, when saying that the uplink traffic gate opens, it is equivalent to say that the uplink traffic gate allows the uplink traffic to pass through the radio modem. On the contrary, when saying that the uplink traffic gate closes, it is equivalent to say that the uplink traffic gate prevents the uplink traffic from passing through the radio modem.

According to some implementations, the aforementioned at least one uplink traffic gating strategy may comprise an alarm-aware uplink traffic gating strategy. In addition, the traffic control module 114 is capable of receiving a wake-up type alarm trigger from the alarm grouping control module 112, determining whether a time interval between the wake-up type alarm trigger and a last time point when uplink traffic is previously allowed because of another alarm trigger reaches a predetermined alarm-triggered gate open threshold Tₐₗₐᵣₘ (e.g. five minutes by default, or any other length of time), and controlling whether to allow uplink traffic to pass through the radio modem according to whether this time interval reaches the predetermined alarm-triggered gate open threshold Tₐₗₐᵣₘ. When this time interval reaches the predetermined alarm-triggered gate open threshold Tₐₗₐᵣₘ, the traffic control module 114 may control the aforementioned uplink traffic gating mechanism within the electronic device to allow uplink traffic to pass through the radio modem; otherwise (e.g. when this time interval does not reach the predetermined alarm-triggered gate open threshold Tₐₗₐᵣₘ), the traffic control module 114 may control the uplink traffic gating mechanism to prevent uplink traffic from passing through the radio modem.

Taking the implementation shown in FIG. 4 as an example, the predetermined alarm-triggered gate open threshold Tₐₗₐᵣₘ can be utilized as an alarm minimum gate open release time. Within the wake-up type alarm triggers shown around the uppermost of FIG. 4, the second one, the third one, and the fourth one of them (i.e. those except for the leftmost one) can be taken as an example of the aforementioned wake-up type alarm trigger, respectively, where the beginning time point of the alarm minimum gate open release time can be taken as an example of the aforementioned last time point when uplink traffic is previously allowed because of the other alarm trigger. For example, each of the second one and the third one of them, or those except for the leftmost one and the rightmost one, appears at a time point that falls within the alarm minimum gate open release time, and therefore this time interval does not reach the predetermined alarm-triggered gate open threshold Tₐₗₐᵣₘ. Therefore, based upon the alarm-aware uplink traffic gating strategy, the traffic control module 114 may control the uplink traffic gating mechanism to temporarily prevent uplink traffic from passing through the radio modem, until the uplink traffic gate implemented according to the uplink traffic shaping control scheme shown in FIG. 4 opens. As a result, in FIG. 4, the second one and the third one of them is delayed for a while, respectively, and uplink traffic of the second one and the third one of them are delayed correspondingly. In another example, the fourth one of them (i.e. the rightmost one) appears at a time point that falls outside the alarm minimum gate open release time, and therefore this time interval reaches the predetermined alarm-triggered gate open threshold Tₐₗₐᵣₘ. Therefore, based upon the alarm-aware uplink traffic gating strategy, the traffic control module 114 may control the aforementioned uplink traffic gating mechanism within the electronic device to allow uplink traffic to pass through the radio modem. As a result, in FIG. 4, the fourth one of them is not delayed, and uplink traffic of the fourth one of them is not delayed correspondingly.

According to some implementations, the aforementioned at least one uplink traffic gating strategy may comprise a modem-state-aware uplink traffic gating strategy. In addition, any modem state within the aforementioned at least one modem state is a RRC state of the radio modem. For example, when it is detected that the radio modem is in the RRC Connected state, the traffic control module 114 may control the uplink traffic gating mechanism to allow uplink traffic to pass through the radio modem. In another example, when it is detected that the radio modem is in the RRC Idle state, the traffic control module 114 may control the uplink traffic gating mechanism to prevent uplink traffic from passing through the radio modem. Taking the implementation shown in FIG. 4 as an example, the modem-state-aware uplink traffic gating strategy and the alarm-aware uplink traffic gating strategy may be used together. Within the wake-up type alarm triggers shown around the uppermost of FIG. 4, the second one and the third one of them are delayed. For example, the uplink traffic of the second one of them is prevented from passing through the radio modem when it is detected that the radio modem is in the RRC Idle state, and is allowed to pass through the radio modem when it is detected that the radio modem is in the RRC Connected state. In another example, the uplink traffic of the third one of them is prevented from passing through the radio modem when it is detected that the radio modem is in the RRC Idle state, and is allowed to pass through the radio modem when it is detected that the radio modem is in the RRC Connected state.

According to some implementations, the aforementioned at least one uplink traffic gating strategy may comprise a close-time-aware uplink traffic gating strategy. In addition, when it is detected that uplink traffic has been prevented from passing through the radio modem for a time period that is greater than a predetermined non-alarm-triggered gate open threshold T_{close}, the traffic control module 114 may control the uplink traffic gating mechanism to allow uplink traffic to pass through the radio modem. Taking the implementation shown in FIG. 4 as an example, although the close-time-aware uplink traffic gating strategy, the modem-state-aware uplink traffic gating strategy, and the alarm-aware uplink traffic gating strategy may be used together, an operation corresponding to the close-time-aware uplink traffic gating strategy may be performed independently with respect to that of the modem-state-aware uplink traffic gating strategy and the alarm-aware uplink traffic gating strategy, respectively. The uplink traffic gate implemented according to the uplink traffic shaping control scheme shown in FIG. 4 once opens in the beginning, and then closes for a time period. As this time period reaches the predetermined non-alarm-triggered gate open threshold T_{close}, based upon the close-time-aware uplink traffic gating strategy, the traffic control module 114 immediately controls the uplink traffic gating mechanism to allow uplink traffic to pass through the radio modem. As a result, the uplink traffic gate will not be continuously closed too long.

According to some implementations, the aforementioned at least one uplink traffic gating strategy may comprise a kernel-aware uplink traffic gating strategy. In addition, according to the aforementioned at least one modem state and according to the aforementioned at least one uplink traffic gating strategy, the traffic control module 114 may dynamically control whether to allow uplink traffic, which comprises kernel uplink traffic, to pass through the radio modem. For example, in addition to user uplink data traffic, kernel uplink data traffic must be blocked, too. Taking the implementation shown in FIG. 4 as an example, the kernel-aware uplink traffic gating strategy, the modem-state-aware uplink traffic gating strategy, and the alarm-aware uplink traffic gating strategy may be used together. Within the wake-up type alarm triggers shown around the uppermost of FIG. 4, the second one and the third one of them are delayed. For example, both of the uplink traffic of the second one of them and the kernel uplink traffic are prevented from passing through the radio modem when it is detected that the radio modem is in the RRC Idle state, and are allowed to pass through the radio modem when it is detected that the radio modem is in the RRC Connected state. In another example, both of the uplink traffic of the third one of them and the kernel uplink traffic are prevented from passing through the radio modem when it is detected that the radio modem is in the RRC Idle state, and are allowed to pass through the radio modem when it is detected that the radio modem is in the RRC Connected state.

According to some implementations, the aforementioned at least one uplink traffic gating strategy may comprise a user-first uplink traffic gating strategy. In addition, when the screen of the electronic device (e.g. the display module 210 shown in FIG. 2) is turned off and no charging operation of the battery of the electronic device is performed, according to the aforementioned at least one modem state and according to the aforementioned at least one uplink traffic gating strategy, the traffic control module 114 may dynamically control whether to allow uplink traffic to pass through the radio modem. For example, the user-first uplink traffic gating strategy may be designed to prevent unpleasant user experience, and the processing circuit 110 executing the program codes may enable the operations of Step 320 (and more particularly, may enable the operations regarding the uplink traffic shaping control scheme shown in FIG. 4) when the screen of the electronic device is turned off and no charging operation of the battery of the electronic device is performed, and may disable the operations of Step 320 (and more particularly, may disable the operations regarding the uplink traffic shaping control scheme shown in FIG. 4) when the screen of the electronic device is turned on and/or a charging operation of the battery of the electronic device is performed. This is for illustrative purposes only, and is not meant to be a limitation of the present disclosure. According to some implementations of the present disclosure, the processing circuit 110 executing the program codes may enable the operations of Step 320 (and more particularly, may enable the operations regarding the uplink traffic shaping control scheme shown in FIG. 4) when the screen of the electronic device is turned off, and may disable the operations of Step 320 (and more particularly, may disable the operations regarding the uplink traffic shaping control scheme shown in FIG. 4) when the screen of the electronic device is turned on. According to some implementations of the present disclosure, when it is detected that the radio modem is in an idle state (such as the RRC Idle state), the traffic control module 114 may control the uplink traffic gating mechanism to prevent uplink traffic from passing through the radio modem. As a result of the alignment with the modem connection status, consecutive data transmission will not be interrupted, and more power benefit may be achieved by closing the uplink availability whenever modem enters the idle state.

Taking the implementation shown in FIG. 4 as an example, based upon the user-first uplink traffic gating strategy, if the screen of the electronic device is turned off and no charging operation of the battery of the electronic device is performed, the operations corresponding to the modem-state-aware uplink traffic gating strategy and the alarm-aware uplink traffic gating strategy may be performed as mentioned above; otherwise (e.g. the screen of the electronic device is turned on by the user, and/or a charging operation of the battery of the electronic device is performed currently), the traffic control module 114 may temporarily stop using the uplink traffic shaping control scheme shown in FIG. 4. For example, when the user turns on the screen of the electronic device, the traffic control module 114 may allow any uplink traffic to pass through the radio modem, so that the user will not feel any delay (if exists, in this example) caused by using the uplink traffic shaping control scheme shown in FIG. 4. Please note that, in most cases, the user may not feel this delay since the operations corresponding to the close-time-aware uplink traffic gating strategy are quite helpful on releasing the delayed uplink traffic. However, in a situation where the user is uploading a file (e.g. the user is uploading a video clip onto a server), the user may feel this delay. Based upon the user-first uplink traffic gating strategy, the traffic control module 114 may allow any uplink traffic to pass through the radio modem, so that the user will not feel this delay in this situation. In another example, when the user connects the electronic device to an external power source to start charging the battery of the electronic device, the traffic control module 114 may allow any uplink traffic to pass through the radio modem, since the power is supposed to be sufficient no matter whether to use the uplink traffic shaping control scheme shown in FIG. 4.

According to some implementations, as a result of maintaining the minimum time period between uplink gate opening timings, more power benefit may be achieved by reducing uplink gate open time. According to some implementations, as a result of the alignment with wakeup alarm execution, more power benefit may be achieved by sharing more hardware resource since most user space data connections are triggered by wake-type alarms. According to some implementations, as a result of controlling uplink traffic only (rather than controlling downlink traffic), the downlink activities will not be affected, so that instant messaging applications (APPs) may work normally with long-living connection to get message immediately.

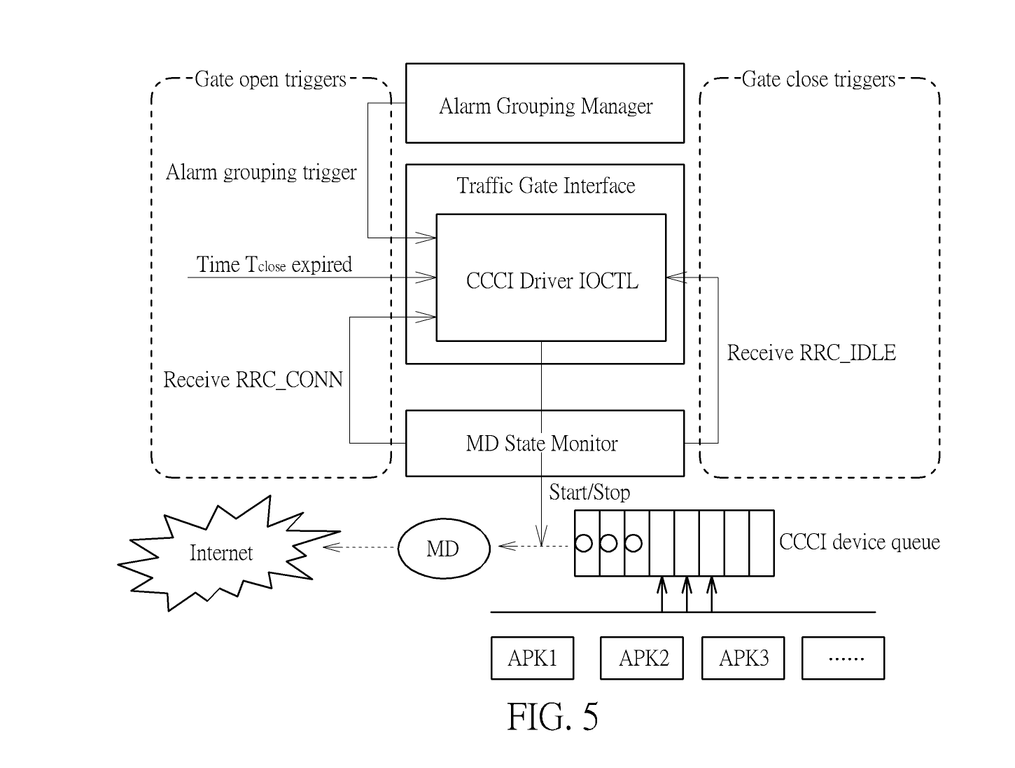

FIG. 5 illustrates an alarm-aware mechanism involved with the method 300 shown in FIG. 3 according to an implementation of the present disclosure, where this alarm-aware mechanism can be taken as an example of the apparatus 100 shown in FIG. 1. The modem (labeled “MD” in FIG. 5, for brevity) in this alarm-aware mechanism can be taken as an example of the radio modem mentioned above. In addition, the alarm grouping manager shown in FIG. 5 can be taken as an example of the alarm grouping control module 112, the traffic gate interface shown in FIG. 5 can be taken as an example of the traffic control module 114, and the modem state monitor (labeled “MD state monitor” in FIG. 5, for brevity) in the alarm-aware mechanism shown in FIG. 5 can be taken as an example of the monitoring module 116. Additionally, the uplink traffic gating mechanism may comprise a cross chip communications interface (CCCI) device, which is the interface between the radio modem and the processing circuit 110 running some applications, such as the interface between the “Modem” and the “AP” shown in FIG. 4. For example, this CCCI device of this implementation may be implemented as a CCCI device queue, and whether to send out any data in the CCCI device queue may be controlled by the traffic gate interface. Please note that the traffic gate interface of this implementation may comprise a CCCI driver and input/output (I/O) control module (labeled “CCCI Driver IOCTL” in FIG. 5, for brevity) that is capable of driving the CCCI device and is further capable of performing I/O control for the traffic gate interface. Based on the architecture shown in FIG. 5, the traffic gate interface may perform uplink traffic gating by controlling whether to start or stop sending the uplink traffic data in the CCCI device queue toward the aforementioned radio modem such as the modem (MD) shown in FIG. 5. For example, the circles illustrated within the CCCI device queue may represent data that currently exists in the CCCI device queue, and other data from some application modules APK1, APK2, APK3, etc. may be arranged to further store in the CCCI device queue for their uplink transmissions, respectively. For brevity, similar descriptions for this implementation are not repeated in detail here.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for performing uplink traffic shaping of an electronic device, the method comprising the steps of:
monitoring at least one modulator-demodulator (modem) state of a radio modem of the electronic device; and
according to the at least one modem state and according to at least one uplink traffic gating strategy, dynamically controlling whether to allow uplink traffic to pass through the radio modem.

2. The method of claim 1, wherein the at least one uplink traffic gating strategy comprises an alarm-aware uplink traffic gating strategy; and the step of dynamically controlling whether to allow uplink traffic to pass through the radio modem further comprises:
receiving a wake-up type alarm trigger;
determining whether a time interval between the wake-up type alarm trigger and a last time point when uplink traffic is previously allowed because of another alarm trigger reaches a predetermined alarm-triggered gate open threshold; and
controlling whether to allow uplink traffic to pass through the radio modem according to whether the time interval reaches the predetermined alarm-triggered gate open threshold.

3. The method of claim 2, wherein the step of dynamically controlling whether to allow uplink traffic to pass through the radio modem further comprises:
when the time interval reaches the predetermined alarm-triggered gate open threshold, controlling an uplink traffic gating mechanism within the electronic device to allow uplink traffic to pass through the radio modem.

4. The method of claim 2, wherein the step of dynamically controlling whether to allow uplink traffic to pass through the radio modem further comprises:
when the time interval does not reach the predetermined alarm-triggered gate open threshold, controlling an uplink traffic gating mechanism within the electronic device to prevent uplink traffic from passing through the radio modem.

5. The method of claim 1, wherein the at least one uplink traffic gating strategy comprises a modem-state-aware uplink traffic gating strategy; any modem state within the at least one modem state is a radio resource control (RRC) state of the radio modem; and the step of dynamically controlling whether to allow uplink traffic to pass through the radio modem further comprises:
when it is detected that the radio modem is in a RRC Connected state, controlling an uplink traffic gating mechanism within the electronic device to allow uplink traffic to pass through the radio modem.

6. The method of claim 1, wherein the at least one uplink traffic gating strategy comprises a modem-state-aware uplink traffic gating strategy; any modem state within the at least one modem state is a radio resource control (RRC) state of the radio modem; and the step of dynamically controlling whether to allow uplink traffic to pass through the radio modem further comprises:
when it is detected that the radio modem is in a RRC Idle state, controlling an uplink traffic gating mechanism within the electronic device to prevent uplink traffic from passing through the radio modem.

7. The method of claim 1, wherein the at least one uplink traffic gating strategy comprises a close-time-aware uplink traffic gating strategy; and the step of dynamically controlling whether to allow uplink traffic to pass through the radio modem further comprises:
when it is detected that uplink traffic has been prevented from passing through the radio modem for a time period that is greater than a predetermined non-alarm-triggered gate open threshold, controlling an uplink traffic gating mechanism within the electronic device to allow uplink traffic to pass through the radio modem.

8. The method of claim 1, wherein the at least one uplink traffic gating strategy comprises a kernel-aware uplink traffic gating strategy; and the step of dynamically controlling whether to allow uplink traffic to pass through the radio modem further comprises:
according to the at least one modem state and according to the at least one uplink traffic gating strategy, dynamically controlling whether to allow uplink traffic, which comprises kernel uplink traffic, to pass through the radio modem.

9. The method of claim 1, wherein the at least one uplink traffic gating strategy comprises a user-first uplink traffic gating strategy; and the step of dynamically controlling whether to allow uplink traffic to pass through the radio modem further comprises:
when a screen of the electronic device is turned off and no charging operation of a battery of the electronic device is performed, according to the at least one modem state and according to the at least one uplink traffic gating strategy, dynamically controlling whether to allow uplink traffic to pass through the radio modem.

10. The method of claim 1, wherein the step of dynamically controlling whether to allow uplink traffic to pass through the radio modem further comprises:
when it is detected that the radio modem is in an idle state, controlling an uplink traffic gating mechanism within the electronic device to prevent uplink traffic from passing through the radio modem.

11. An apparatus for performing uplink traffic shaping of an electronic device, the apparatus comprising at least one portion of an electronic device, the apparatus comprising:
a processing circuit, arranged for controlling operations of the electronic device, wherein the processing circuit comprises:
a monitoring module, arranged for monitoring at least one modulator-demodulator (modem) state of a radio modem of the electronic device; and
a traffic control module, arranged for performing uplink traffic control for the electronic device, wherein according to the at least one modem state and according to at least one uplink traffic gating strategy, the traffic control module dynamically controls whether to allow uplink traffic to pass through the radio modem.

12. The apparatus of claim 11, wherein the at least one uplink traffic gating strategy comprises an alarm-aware uplink traffic gating strategy; and the processing circuit further comprises:
an alarm grouping control module, arranged for performing alarm grouping control for the electronic device, wherein the traffic control module receives a wake-up type alarm trigger from the alarm grouping control module, determines whether a time interval between the wake-up type alarm trigger and a last time point when uplink traffic is previously allowed because of another alarm trigger reaches a predetermined alarm-triggered gate open threshold, and controls whether to allow uplink traffic to pass through the radio modem according to whether the time interval reaches the predetermined alarm-triggered gate open threshold.

13. The apparatus of claim 12, wherein when the time interval reaches the predetermined alarm-triggered gate open threshold, the traffic control module controls an uplink traffic gating mechanism within the electronic device to allow uplink traffic to pass through the radio modem.

14. The apparatus of claim 12, wherein when the time interval does not reach the predetermined alarm-triggered gate open threshold, the traffic control module controls an uplink traffic gating mechanism within the electronic device to prevent uplink traffic from passing through the radio modem.

15. The apparatus of claim 11, wherein the at least one uplink traffic gating strategy comprises a modem-state-aware uplink traffic gating strategy; any modem state within the at least one modem state is a radio resource control (RRC) state of the radio modem; and when it is detected that the radio modem is in a RRC Connected state, the traffic control module controls an uplink traffic gating mechanism within the electronic device to allow uplink traffic to pass through the radio modem.

16. The apparatus of claim 11, wherein the at least one uplink traffic gating strategy comprises a modem-state-aware uplink traffic gating strategy; any modem state within the at least one modem state is a radio resource control (RRC) state of the radio modem; and when it is detected that the radio modem is in a RRC Idle state, the traffic control module controls an uplink traffic gating mechanism within the electronic device to prevent uplink traffic from passing through the radio modem.

17. The apparatus of claim 11, wherein the at least one uplink traffic gating strategy comprises a close-time-aware uplink traffic gating strategy; and when it is detected that uplink traffic has been prevented from passing through the radio modem for a time period that is greater than a predetermined non-alarm-triggered gate open threshold, the traffic control module controls an uplink traffic gating mechanism within the electronic device to allow uplink traffic to pass through the radio modem.

18. The apparatus of claim 11, wherein the at least one uplink traffic gating strategy comprises a kernel-aware uplink traffic gating strategy; and according to the at least one modem state and according to the at least one uplink traffic gating strategy, the traffic control module dynamically controls whether to allow uplink traffic, which comprises kernel uplink traffic, to pass through the radio modem.

19. The apparatus of claim 11, wherein the at least one uplink traffic gating strategy comprises a user-first uplink traffic gating strategy; and when a screen of the electronic device is turned off and no charging operation of a battery of the electronic device is performed, according to the at least one modem state and according to the at least one uplink traffic gating strategy, the traffic control module dynamically controls whether to allow uplink traffic to pass through the radio modem.

20. The apparatus of claim 11, wherein when it is detected that the radio modem is in an idle state, the traffic control module controls an uplink traffic gating mechanism within the electronic device to prevent uplink traffic from passing through the radio modem.
